(19) United States
(12) Patent Application Publication
(10) Pub. No.: US 2010/0298025 A1
(43) Pub. Date: Nov. 25, 2010

(54) Waterproof cell phone

(76) Inventor: Cezar Spence, Bowie, MD (US)

Correspondence Address: RUTH EURE, 4795 EDISON AVENUE, BOULDER, CO, 80301, US

(21) Appl. No.: 12/800,233

(22) Filed: May 10, 2010

Related U.S. Application Data
(60) Provisional application No. 61/216,578, filed on May 19, 2009.

(51) Int. Cl. H04W 88/02

(52) U.S. Cl. 455/550.1

(57) ABSTRACT

The present invention provides a Waterproof Cell Phone which addresses the problem of waterproofing a cell phone by providing a seamless, flexible, transparent, waterproof covering for the phone, such that the phone operates as a normal cell phone, yet be impenetrable to moisture, even to water immersion. Cell phones, typically present three avenues by which water can get in and damage them. First, the earpiece or receiver of the phone contains a speaker; second, the mouthpiece contains a microphone; and third, the recharging socket presents another passage from the exterior of the phone to the electronic interior. Covering these three components is crucial to waterproofing the phone. In the case of the recharging receptacle, a snap-cover hatch will protect the phone, and the user simply snaps the cover off in order to plug in the adapter and recharge the phone. In the case of the earpiece speaker and mouthpiece microphone, as well as the keyboard and function buttons, a form-fitting, molded, flexible, transparent plastic film fully encloses and encases the phone, yet allows the passage of sound waves necessary for phone function.

### CLAIM OF PRIORITY

This patent application claims priority under 35 USC 119 (e) (1) from U.S. Provisional Patent Application Ser. Number 61/216,578 filed May 19, 2009, of common inventorship herewith entitled, “Waterproof Cell Phone.”

### Field of the Invention

The present invention pertains to the field of phones, and more specifically to the field of cellular devices such as phones and even more specifically to the field of waterproof cell phones.

### BACKGROUND OF THE INVENTION

The prior art has put forth several designs for waterproof phones. Among these are:

U.S. Pat. No. 5,625,688 to Ford et al describes a shower telephone which comprises a cordless phone which is insulated and encased in a plastic sheath to provide a phone which can be safely used in the shower, bath or outside in the rain.

U.S. Pat. No. 6,355,374 to Wirsching describes a phone which is designed to float in the water comprising a detachably affixed battery back comprising buoyancy means and encasement means.

U.S. Pat. No. 7,149,558 to Kakuguchi et al describes a portable terminal device comprising a waterproof housing for receiving the cellular telephone. None of these prior art references describe the present invention.

### BRIEF DESCRIPTION OF THE DRAWING

FIG. 1 is a perspective view of the waterproof cellular device of the present invention.

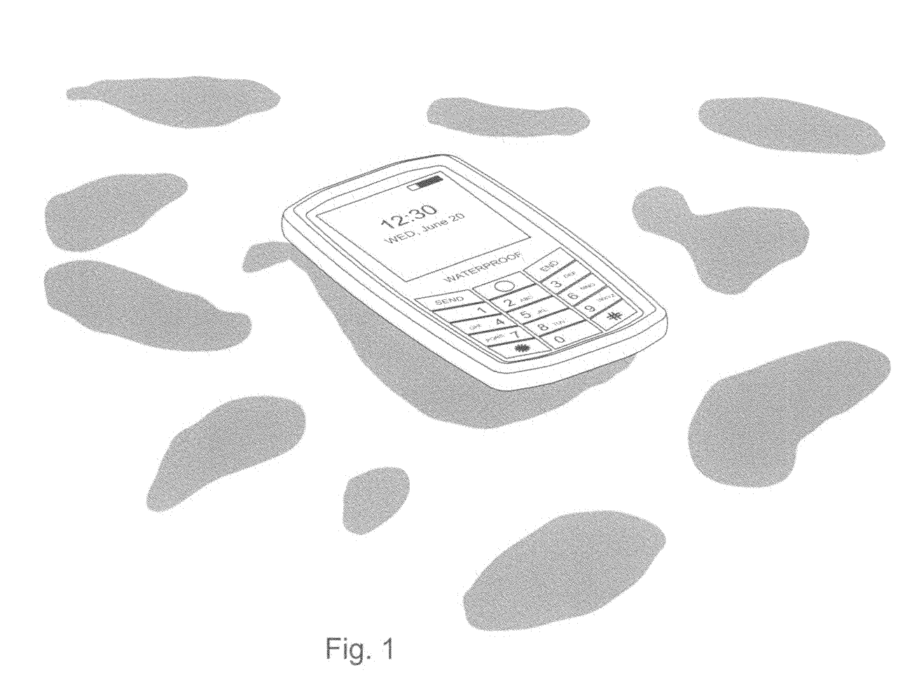

### DETAILED DESCRIPTION OF THE INVENTION

Personal electronic devices, such as the cell phone, the laptop computer, cable TV, the PDA or Blackberry, the i-Pod, the i-Phone have dramatically changed the way we live, and most of us would be lost without, for example, our cell phones. But while almost all of us these days depend heavily on our cell phones for voice communication and texting, even for taking pictures and surfing the internet, one thing sadly lacking in cell phones is durability. Cell phones do not fare well if dropped, and if you happen to drop yours in water, the device is rendered inoperable. You have lost not only your phone, a significant financial expense, but all the information, contacts, messages, and numbers programmed into it.

The present invention provides a solution to this problem. Recognizing the very substantial drawback presented by the fact that cell phones have yet to be designed and constructed in a waterproof manner, the present invention, hereinafter referred to as the Waterproof Cell Phone was developed.

Simply stated, the Waterproof Cell Phone comprises a top-quality cell phone, the distinguishing common feature of which is its imperviousness to damage from water immersion. The Waterproof Cell Phone will be Manufactured by the Radio and Television Broadcasting and Communications Equipment industry, Standard Industrial Code 3663.

Basically, however, the Waterproof Cell Phone addresses the problem of waterproofing a cell phone by providing a seamless, flexible, transparent, waterproof covering for the phone, such that the phone operates as a normal cell phone, yet be impenetrable to moisture, even to water immersion. Cell phones, typically present three avenues by which water can get in and damage them. First, the earpiece or receiver of the phone contains a speaker; second, the mouthpiece contains a microphone; and third, the recharging socket presents another passage from the exterior of the phone to the electronic interior. Covering these three components is crucial to waterproofing the phone. In the case of the recharging receptacle, a snap-cover hatch will protect the phone, and the user simply snaps the cover off in order to plug in the adapter and recharge the phone. In the case of the earpiece speaker and mouthpiece microphone, as well as the keyboard and function buttons, a form-fitting, molded, flexible, transparent plastic film fully encloses and encases the phone, yet allows the passage of sound waves necessary for phone function. The watertight covering can be comprised of any waterproof material, such as silicon, for example.

The Waterproof Cell Phone, a product line of multi-function cell phones that are impervious to water, presents a singular and distinct advantage over other cell phones currently on the market. Cell phones, for almost all of us, have become the dominant means of communication, whether for work, family, friends, or in emergencies, and yet these devices, which not only allow us to communicate but also function as databases for all our contacts and numbers, can be instantly ruined if they slip from our hands. Since many of us tend to use our cell phones on a near-constant basis, they can be dropped into sinks full of dishwater, bathtubs, toilets. With the Waterproof Cell phone, such accidents would not ruin the phone. The Waterproof Cell Phone is impervious to water damage, yet would provide the full-featured service that cell phone users expect, all at a price competitive with standard, top-quality cell phones.

For men and women who work outdoors in challenging weather conditions, for teens who chat on the phone when soaking in the tub, and for virtually all consumers who enjoy cell phone service and convenience, the Waterproof Cell Phone will save the financial expense of replacing a ruined phone, and eliminate the major hassle and annoyance of gathering and re-entering one's contacts and numbers.

A product line of cellular telephones, the distinguishing design feature of which is their imperviousness to water immersion, the Waterproof Cell Phone performs all the functions of a standard high-quality cell phone, and be invulnerable to water damage. The affordable, full-featured Waterproof Cell Phone will find a wide and receptive market among the consumer household.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A waterproof cell phone, comprising a seamless, flexible, transparent, waterproof covering for a phone, such that the phone operates as a normal cell phone, and is impenetrable to moisture, even to water immersion comprising a watertight covering for the earpiece or receiver containing a speaker, a watertight covering for the mouthpiece containing a microphone, and a watertight covering for the recharging socket.

2. The waterproof cell phone of claim 1 wherein the watertight covering for recharging receptacle comprises a snap-cover hatch and the user simply snaps the cover off in order to plug in the adapter and recharge the phone.

3. The waterproof cell phone of claim 1 wherein the watertight covering for the earpiece speaker and mouthpiece microphone, as well as the keyboard and function buttons, comprises a form-fitting, molded, flexible, transparent plastic film fully enclosing and encasing the phone.

4. The waterproof cell phone of claim 1 wherein the watertight coverings comprise silicon.
